(19) United States
(12) Patent Application Publication
(10) Pub. No.: US 2012/0158763 A1
(43) Pub. Date: Jun. 21, 2012

(54) BULK OPERATIONS

(75) Inventor: Henricus Johannes Maria Meijer, Mercer Island, WA (US)

(73) Assignee: MICROSOFT CORPORATION, Redmond, WA (US)

(21) Appl. No.: 12/971,864

(22) Filed: Dec. 17, 2010

(51) Int. Cl. G06F 17/30

(52) U.S. Cl. 707/760; 707/E17.13

(57) ABSTRACT

Bulk operations including create, update, and delete operations are supported within the context of language-integrated queries. Such bulk operations can be implemented as distinct operations. Other operations, including query operators defining a collection of data over which the bulk operations can execute, can be restricted as a function of a specific bulk operation.

### BACKGROUND

Data processing is a fundamental part of computer programming. One can choose from amongst a variety of programming languages with which to author programs. The selected language for a particular application may depend on the application context, a developer's preference, or a company policy, among other factors. Regardless of the selected language, a developer will ultimately have to deal with data, namely querying as well as creating, updating, and deleting data.

A technology called language-integrated queries (LINQ) was developed to facilitate querying, or in other words reading, data from within programming languages. LINQ provides a convenient and declarative shorthand query syntax to enable specification of queries within a programming language (e.g., C#®, Visual Basic® . . . ). More specifically, query operators are provided that map to lower-level language constructs or primitives such as methods and lambda expressions. Query operators are provided for various families of operations (e.g., filtering, projection, joining, grouping, ordering . . . ), and can include but are not limited to “where” and “select” operators that map to methods that implement the operators that these names represent. By way of example, a user can specify a query expression in a form such as “from n in numbers where n<10 select n,” wherein “numbers” is a data source and the query returns integers from the data source that are less than ten. Further, query operators can be combined in various ways to generate queries of arbitrary complexity.

To perform create, update and delete operations within a programming language, the querying functionality of LINQ can be exploited. More specifically, a collection of data over which create, update, or delete operations can be performed is read into memory from a persistent data store (e.g., non-volatile repository for data) utilizing LINQ. Subsequently, one or more operations are performed on the in-memory representation and changes are pushed back to the persistent data store. In other words, changes on entities retrieved from a database can be tracked and when a “SubmitChanges( )” procedure, or the like, is called on the database, accumulated changes are performed on underlying data structures (e.g., tables).

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to bulk operations. Create, read, update, and delete operations can be specified utilizing language-integrated queries. However, each bulk operation can be implemented distinct from other bulk operations as opposed to as a function of a particular operation such as a read operation, for example. In addition, functionality related to bulk operations can be constrained as a function of a particular bulk operation to prevent, or at least reduce, runtime errors. In accordance with one aspect of the disclosure, bulk operations can operate with respect to specialized collections of a type specific to an operation (e.g., IQuerable, IInsertable, IUpdatable, IDeletable). Furthermore, other operations over the collection can be restricted based on the type of collection including but not limited to query operators employed to define the collection.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that facilitates interaction with at persistent data store.

FIG. 2 is a block diagram of a representative LINQ bulk operation.

FIGS. 3A-C graphically depict create, update, and delete operations.

FIG. 4 is a flow chart diagram of a method of interacting with a persistent data store.

FIG. 5 is a flow chart diagram of a method of coding a bulk operation.

FIG. 6 is a flow chart diagram of method of validating bulk operations.

FIG. 7 is a schematic block diagram illustrating a suitable operating environment for aspects of the subject disclosure.

### DETAILED DESCRIPTION

Details below are generally directed toward bulk operations including create, update, and delete in a language-integrated query context. Conventionally, a single bulk operation is supported, namely a read operation. Code can be injected to exploit the read operation to perform other bulk operations, for example, by reading data from a persistent data store (e.g., database) into memory, enabling changes to occur over the in-memory data, and pushing the changes back to the persistent data store.

There are, however, least two problems associated with the aforementioned approach. First, while for read operations it is desirable to load data into memory, for other bulk operations it is preferable to perform the operations directly on a persistent data store without creating an in-memory representation (e.g., object) at least for efficiency reasons. For example, consider a scenario involving a million records. Here, loading the million records from a persistent data store, tracking changes, and pushing data back to the persistent data store would be quite inefficient. Second, collections identified by read queries can be incompatible with respect to other operations and thus cause runtime errors. For instance, if a “Join” query operator were executed over multiple tables, a delete operation would be difficult, if not impossible, to performed since the tables for which particular data is received are unknown. The subject disclosure addresses these and other issues.

More specifically, bulk operators are provided that are distinct from each other, rather than being modified read operations. Accordingly, create, update, and delete operations can be executed directly on a persistent data store instead of indirectly with local modifications and subsequent submissions to the data store. Further, the intent of an operation can be specified prior to specification of a collection, for example utilizing query syntax, over which the operation executes. In accordance with one embodiment, each operation can be specified with respect to a particular collection type (e.g., IInsertable<T>, IUpdatable<T>, IDeletable<T>) that can limit the variety of query operators that can be utilized to a define a collection, among other operations.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

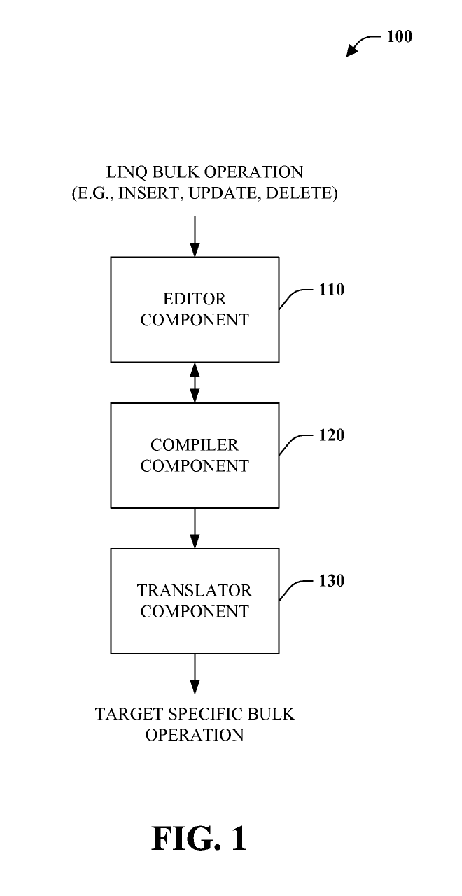

Referring initially to FIG. 1, a system 100 that facilitates interaction with a persistent data store such as a database is illustrated. The system 100 includes an editor component 110 that is configured to receive, retrieve or otherwise obtain or acquire source code of computer programs. More specifically, the editor component 110 can enable specification and/or editing of language-integrated query (LINQ) bulk operations.

The bulk operations correspond to basic database operations or, in other words, so-called CRUD operations, namely create, read, update, and delete. The create operation inserts a set of one or more items into a collection. Accordingly, the create operation is also referred to herein as an insert operation. The read operation retrieves at least a subset of items from a collection. Sometimes the read operation is referred to loosely as query operation since the query specifies data to be read. As will be discussed further herein, however, query can specify collections of data over which multiple operations can be performed. The update operation modifies at least a subset of items in a collection, and the delete removes at least a subset of items in a collection.

Conventional language-integrated queries pertain to read operations. Such functionality is afforded with an “IQuerable” interface, which, as the name suggests, identifies a set of items with a query. For example, given a database of patents, one can identify those patents whose author field contains “John Smith” by constructing the following language-integrated query:
var patents=from patent in USPTO.GetTable<Patents>( ) where patent.Author.Includes (“John Smith”) select patent;

Create, update, and delete operations can be implemented as modified read operations. By way of example, and not limitation, to change the name “John Smith” to “Jonathan Smith” the above read operation can be employed to acquire patents with an author “John Smith,” in combination with the below code snippet:

foreach(var patent in patents)
{

Patent.Author = “Jonathan Smith”

}
USPTO.SubmitChanges( );

In other words, an update operation can be performed with a read operation that reads all items into memory, followed by a modification of in memory items, and then accumulated changes are sent back to the database to implement changes to actual underlying data structures (e.g. table).

While for a read operation it is desired that identified items be read into memory, for the other operations, create, update, and delete it is unnecessary. As a result, implementing the other operations as a modified read operation (e.g., read plus additional functionality) can be quite inefficient. In addition, such an implementation can also impose potential limits on operations as a function of a client computer system. By illustrative example, assume in the above example there are a million patents that have an author “John Smith.” It would be very inefficient to bring back a million patents from the database, create the patents in memory, track changes made on them, and then pushing the changes back into the database. Furthermore, if a client computer system cannot create and/or manipulate a million patents in memory then the operation could not be completed.

Still further yet, utilizing a read operation as the basis for other bulk operations can cause problems since the read operation can support more query operators and/or associated functionality than is supported by particular operations. For example, consider the following delete operation implemented on top of a read operation:
var deleted=(from patent in USPTO.GetTable<Patents>( ) where patent.Author.Includes(“John Smith) select patent.Date).Delete( );
   Here, a delete operation is constructed that does not identify any actual items in an underlying table by way of an improper projection. As a result, a runtime error would be generated.

Accordingly, bulk operations with respect to the editor component 110 can be distinct rather than generated on top of a read operation. Furthermore, where language-integrated query expressions, comprising one or more related query operators, among other things, are utilized to identify a collection over which a bulk operation executes, intent can be specified in advance to allow the query expression to be constrained as needed with respect to each bulk operation, namely create, update, and delete. Such functionality can be injected by making changes to underlying programming languages, for example by adding support for specific key words (e.g., Insert, Update, Delete) as well as supporting code. Alternatively, the functionality can be implemented vis-à-vis a type system as described below.

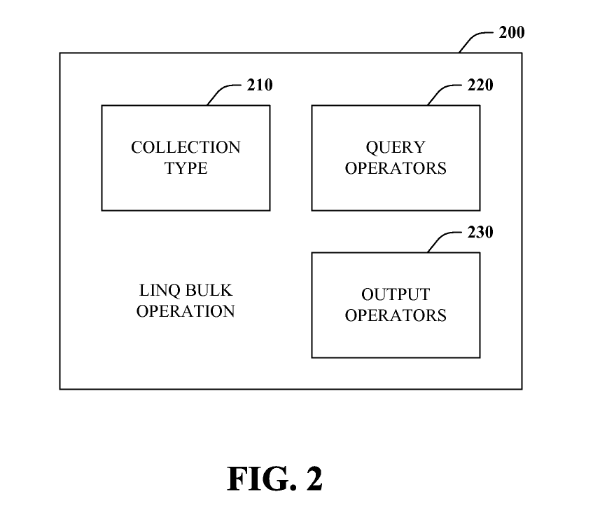

Turning attention to FIG. 2, a representative LINQ bulk operation 200 is graphically depicted. Each LINQ bulk operation (e.g., create, updated, delete) can include a collection type 210 specific to the operation as well as one or more allowable query operators 220 that can operate with respect to a particular collection and type thereof. Furthermore, one or more output operators 230 can be employed to control output of an operation.

The collection type 210 is specific to a particular operation and operates to at least identify intent with respect to a collection specified with respect to a query expression. Moreover, a query expression can be constrained by restricting query operators 220 or utilization thereof with respect to a collection type.

Conventional read operations support the “IQueryable” interface or “IQueryable<T>.” If a collection implements the interface “IQueryable<T>” (where “T” is the type of items in the collection (e.g., String, Integer . . . )), it means the collection implements the functionality prescribed by the interface and as such the collection can be said to be of type “IQueryable<T>.” Similarly, a create operation can implement, and be of, type “IInsertable<T>,” an update operation can implement, and be of, type “IUpdatable<T>,” and a delete operation can implement, and be of, type “IDeletable<T>.” These types of collections can now be utilized to restrict operations (e.g., query operators (Select, Where, Join . . . )) over the collections as a function of a specific bulk operation. In accordance with one embodiment, the bulk operator types “IInsertable<T>,” “IUpdatable<T>,” and “IDeletable<T>” can derive from or be sub-types of the read operation type “IQueryable<T>.” As such, operations can exist to convert between such types.

By way of example and not limitation, a delete operator can be specified with a “GetForDelete<T>( )” operator or the like that returns an “IDeletable<T>” collection from a database.
var deleted=from patent in USPTO.GetForDelete<Patents>( ) where patent.Author.Includes(“John Smith”) select patent;
   Here, the collection type can restrict the variety of query operators that can be applied. More specifically, the collection type can ensure that the result type is “IDeletable<T>” such that the correct type of items are identified for deletion.

Similarly, for creation, or in other words insertion, a “GetForInsertion<T>” operator can be specified that returns an “IInsertable<T>” collection. Furthermore, a concrete collection of values or a query that returns a collection of values, from a potentially different location, can be provided as input to the create operation. For example:
var inserted=USPTO.GetForInsertion<Patents>( ).Insert( from patent in xxx.com.GetTable<Disclosure>( ) where patent.Author.Includes(“John Smith”) select patent);
   var inserted2=inserted.Insert(new Patent{ . . . , Author=“John Smith”, Title=“A better mouse trap”, . . . });

Finally, for updates, a “GetForUpdates<T>” operator can be called that returns an “IUpdatable<T>” collection (not to be confused with the Object Data protocol (OData) notion of updatable). For instance:

var changed=from patent in USPTO.GetForUpdates(old=>{old.Author=“John Smith”;})
where patent.Author.Includes(“John Smith”) select patent;
   Again, the set of query operators on an “IUpdatable<T>” collection maintains the invariant that it can identify solely a subset of the same type.

As shown in FIG. 2, the LINQ bulk operation can also optionally include output operators 230. These operators can be utilized to specify a response with respect to a bulk operation. With a read operation, it is clear the operation has executed when items that satisfy a query are returned. With the other bulk operations, it is less clear since the operations are performed directly on a database, for example. Accordingly, an output operator 230 can be specified for example to return an integer number corresponding to the number of items affected by an operation or the actual items can be returned. For example, when executing a delete specified with a query the number of items deleted can be returned and/or the actual items that were deleted can be returned.

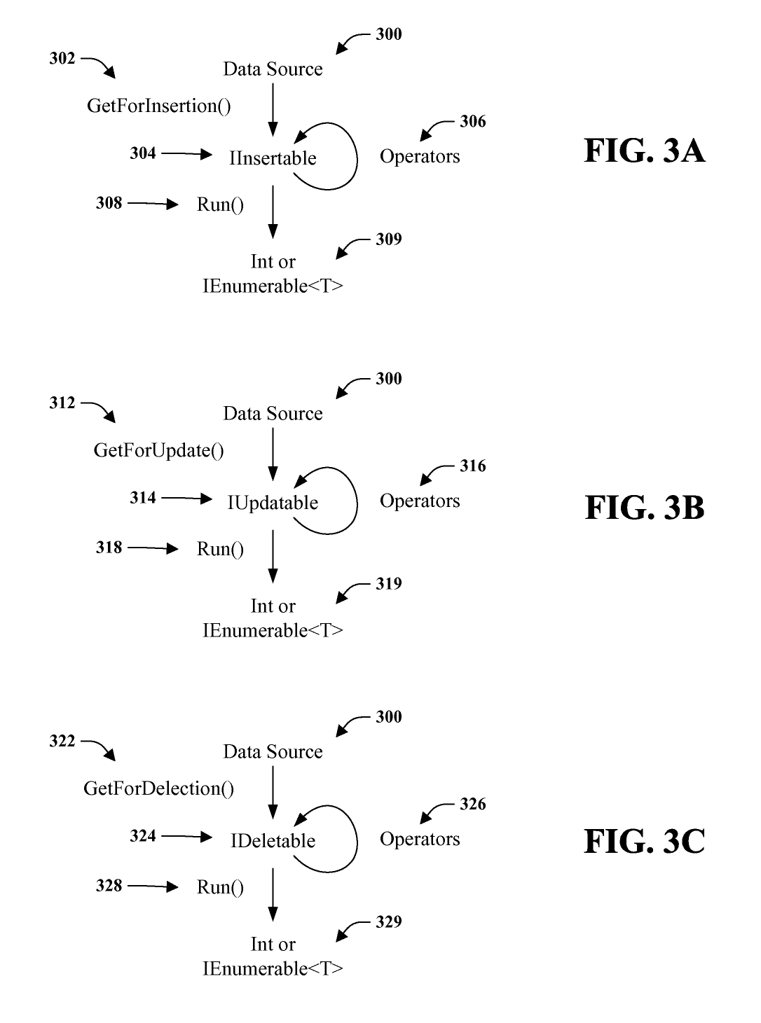

FIGS. 3A-C graphically depict create, update, and delete operations as previously described to further aid clarity and understanding with respect to aspects of the subject disclosure. FIG. 3A pertains to a create or insert operation. As illustrated, a create operation can be performed over a data source 300 such as relational database table. A “GetForinsertion( )” operation 302 can be specified to produce an “IInsertable” collection 304. Over the “IInsertable” collection 304, select query operators 306 can be specified. The create operation can be executed or run 308 on the target data source 300 and in response the number of inserted items or the actual inserted items can be returned as shown as “Int” or “IEnumerable<T>” 309.

FIG. 3B relates to an update operation, which can be performed, again, with respect to a data source 300. Further, a “GetForUpdate” operator 312 can be specified to return an “IUpdatable” collection 314. Allowable operators 316 with respect to the “IUpdatable” collection 314 can be specified to declaratively denote particular items to update. The updated operation can be executed or run 318 on the target data store 300 and either the number of items updated or the actual set of updated items can be returned as captured by “Int” or “IEnumerable<T>” 319.

FIG. 3C concerns a delete operation. Again, items in the data source 300 can be targeted for deletion. A “GetForDeletion” operator 322 can be specified that returns an “IDeletable” collection 324 over which a specific set of query operators 326 can be specified. The delete operation can be executed or run 328 on the data source 300, and a number of items deleted or a set of actual deleted items can be returned as specified as “Int” or “IEnumerable<T>” 329.

Referring back to system 100 of FIG. 1, as mentioned the editor component 110 can enable specification and editing of LINQ bulk operations as previously described. The system 100 also includes a compiler component 120 that can transform source code including LINQ bulk operations into another form such as another computer language. More specifically, the compiler component 120 can perform semantic analysis including type checking or, in other words, checking for type errors. Accordingly, the compiler can inspect collections types specific to bulk operations and determine whether a query expression including one or more operators is acceptable given the particular collection type. If the query expression is not acceptable, a compile time error can be generated. For example, with respect to an “IDeletable<T>” collection if a projection outside an identity projection (e.g., “select patent.Date” rather than “select patent”) is specified the compiler can indicate a type error has occurred. Accordingly, the occurrence of runtime errors can be at least reduced, if not eliminated, with respect to bulk operations.

Furthermore, the editor component 110 and the compiler component 120 can cooperate to provide programmers with substantially real-time feedback regarding specification of bulk operations. For example, the compiler component 120 can be exploited to provide indications of incorrectly specified bulk operations as a function of types, such as through use of red squiggly lines under incorrect portions of code. Further, the compiler component 120 can be utilized to provide hints or make suggestions as source code is entered. For instance, once a collection type is provided or otherwise determined or inferred, query operators can be filtered as a function thereof and suggested during source code specification.

System 100 also includes a translator component 130 that is configured to generate a target-specific bulk operator. More specifically, based on a local representation of a bulk operation produced by the compiler component 120 the translator component 130 can transform that representation into, or from the representation generate, a bulk operation executable by a target execution environment. For example, if the bulk operation is to be executed on a relational database system, the translator component 130 can generated a structured query language (SQL) representation of the bulk operation for execution by the relational database system.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the compiler component 120 can employ such mechanisms with respect to perform type inference, among other things.

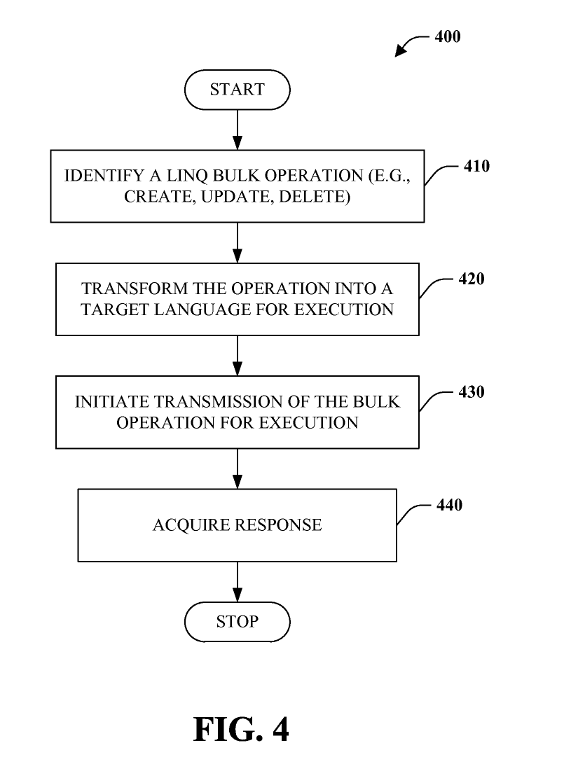

In view of the exemplary systems described supra, methodologies that may be implemented in accordance with the disclosed subject matter will be better appreciated with reference to the flow charts of FIGS. 4-6. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 4, a method 400 of interacting with a persistent data store is illustrated. At reference numeral 410, a language-integrated-query bulk operation is identified. The bulk operation can correspond to a create, update, or delete operation specified utilizing a language-integrated-query expression or the like. At numeral 420, the operation is transformed into a target language for execution. For example, if the bulk operation can be specified in a multi-purpose programming language (e.g., C#®, Visual Basic®, Java) which can later be utilized to produce code executable (e.g., T-SQL) with respect to a persistent data store such relational database system. At 430, transmission, or in other words communication, of the bulk operation for execution is at least initiated. At reference numeral 440, a response can be acquired for example indicating the number of database items affected by the operation and/or providing the actual items that were affected.

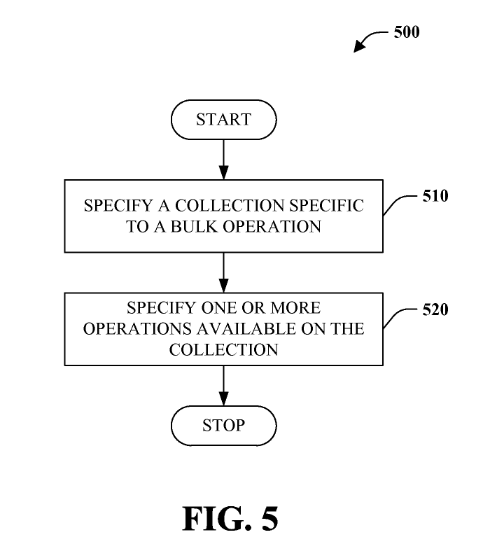

FIG. 5 is a flow chart diagram of a method 500 of coding a bulk operation. At reference numeral 510, a collection type is specified with respect to a bulk operation such as create, update, or delete. Moreover, the collection type specified is unique or specific to a particular bulk operation (e.g., “IInsertable<T>”->create (a.k.a. insert), “IUpdatable<T>”->update, and “IDeletable<T>”->delete). At reference numeral 520, one or more available operations are specified on the specific collection. The collection type can restrict the operations that can be performed on a collection. Accordingly, those operations that have not effectively been filtered can be utilized in the specification of a bulk operation. For example, query operators can be employed to generate a query expression that declaratively specifies at least a subset of data over which a bulk operation can be performed, rather than, or in addition to, explicitly specification of a concrete collection of values, for example. Additionally, output operations can be specified that dictate whether a number of items affected by the operation is returned and/or the particular items are provided.

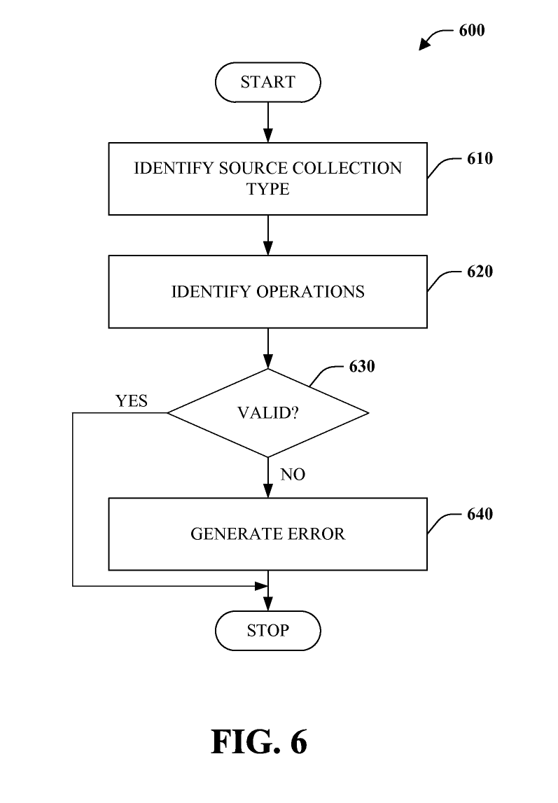

FIG. 6 illustrates a method 600 of validating bulk operations. At reference numeral 610, a source collection type is identified with respect to a specific bulk operation (e.g., create, update, delete), for example “IInsertable<T>,” “IUpdatable<T>,” and “IDeletable<T>.” At numeral 620, operations specific to a collection are identified. For example, query operators and their usage can be identified with respect to a query-expression declaratively defined collection values. At reference 630, determination is made as to whether the operations are valid. Each collection type can define a set of operations that are allowable with respect to a collection. Accordingly, the determination at 630 can correspond to a comparison of allowable operations and specified operation. If the bulk operation is valid as specified (“YES”) (e.g., no type errors), the method 600 can terminate. Alternatively, if the bulk operation is invalid (“NO”) (e.g., type error(s)), the method generates an error at reference numeral 640 prior to terminating.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

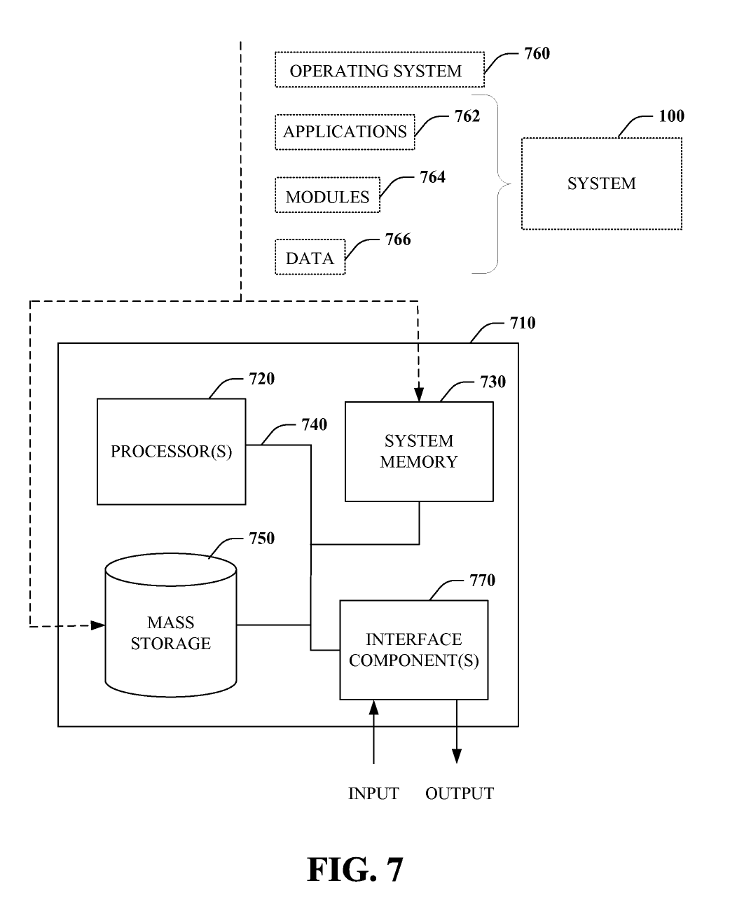

In order to provide a context for the claimed subject matter, FIG. 7 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 7, illustrated is an example general-purpose computer 710 or computing device (e.g., desktop, laptop, server, hand-held, programmable consumer or industrial electronics, set-top box, game system . . . ). The computer 710 includes one or more processor(s) 720, memory 730, system bus 740, mass storage 750, and one or more interface components 770. The system bus 740 communicatively couples at least the above system components. However, it is to be appreciated that in its simplest form the computer 710 can include one or more processors 720 coupled to memory 730 that execute various computer executable actions, instructions, and or components stored in memory 730.

The processor(s) 720 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 720 may also be implemented as a combination of computing devices, for example a combination of a DSP and a microprocessor, a plurality of microprocessors, multi-core processors, one or more microprocessors in conjunction with a DSP core, or any other such configuration.

The computer 710 can include or otherwise interact with a variety of computer-readable media to facilitate control of the computer 710 to implement one or more aspects of the claimed subject matter. The computer-readable media can be any available media that can be accessed by the computer 710 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 710.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 730 and mass storage 750 are examples of computer-readable storage media. Depending on the exact configuration and type of computing device, memory 730 may be volatile (e.g., RAM), non-volatile (e.g., ROM, flash memory . . . ) or some combination of the two. By way of example, the basic input/output system (BIOS), including basic routines to transfer information between elements within the computer 710, such as during start-up, can be stored in nonvolatile memory, while volatile memory can act as external cache memory to facilitate processing by the processor(s) 720, among other things.

Mass storage 750 includes removable/non-removable, volatile/non-volatile computer storage media for storage of large amounts of data relative to the memory 730. For example, mass storage 750 includes, but is not limited to, one or more devices such as a magnetic or optical disk drive, floppy disk drive, flash memory, solid-state drive, or memory stick.

Memory 730 and mass storage 750 can include, or have stored therein, operating system 760, one or more applications 762, one or more program modules 764, and data 766. The operating system 760 acts to control and allocate resources of the computer 710. Applications 762 include one or both of system and application software and can exploit management of resources by the operating system 760 through program modules 764 and data 766 stored in memory 730 and/or mass storage 750 to perform one or more actions. Accordingly, applications 762 can turn a general-purpose computer 710 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100, or portions thereof, can be, or form part, of an application 762, and include one or more modules 764 and data 766 stored in memory and/or mass storage 750 whose functionality can be realized when executed by one or more processor(s) 720.

In accordance with one particular embodiment, the processor(s) 720 can correspond to a system on a chip (SOC) or like architecture including, or in other words integrating, both hardware and software on a single integrated circuit substrate. Here, the processor(s) 720 can include one or more processors as well as memory at least similar to processor(s) 720 and memory 730, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 710 also includes one or more interface components 770 that are communicatively coupled to the system bus 740 and facilitate interaction with the computer 710. By way of example, the interface component 770 can be a port (e.g., serial, parallel, PCMCIA, USB, FireWire . . . ) or an interface card (e.g., sound, video . . . ) or the like. In one example implementation, the interface component 770 can be embodied as a user input/output interface to enable a user to enter commands and information into the computer 710 through one or more input devices (e.g., pointing device such as a mouse, trackball, stylus, touch pad, keyboard, microphone, joystick, game pad, satellite dish, scanner, camera, other computer . . . ). In another example implementation, the interface component 770 can be embodied as an output peripheral interface to supply output to displays (e.g., CRT, LCD, plasma . . . ), speakers, printers, and/or other computers, among other things. Still further yet, the interface component 770 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims

What is claimed is:

1. A method that facilitates interaction with a persistent data store, comprising:
employing at least one processor configured to execute computer-executable instructions stored in memory to perform the following acts:
restricting employment of one or more language-integrated-query operators in relation to specifying at least one of a create, update, or delete operation.

2. The method of claim 1 further comprising initiating execution of the create, update, or delete operation directly on a persistent data store.

3. The method of claim 2 further comprising receiving confirmation of execution of the create, update, or delete operation.

4. The method of claim 3, receiving a set of data affected by the create, update, or delete operation.

5. The method of claim 1 further comprising restricting employment of the one or more language-integrated-query operators as a function of a collection type specific to the create, update, or delete operation.

6. The method of claim 5, restricting the employment as a function of a subtype of a read operation collection type.

7. The method of claim 5 further comprising identifying the collection type from a return type of an operator specific to the create, update, or delete operation.

8. The method of claim 5 further comprises generating a notification if at least one of the one or more language-integrated query operators is unsupported by the collection type.

9. The method of claim 8 further comprising providing the notification through a code editor.

10. A system that facilitates interaction with a persistent data store, comprising:
a processor coupled to a memory, the processor configured to execute the following computer-executable components stored in the memory:
a first component configured to analyze a language-integrated-query create, update, or delete operation over a collection specified with one or more query operators as a function a collection type specific to the operation.

11. The system of claim 10, the first component is configured to generate an error if at least one of the one or more query operators is unsupported by the collection type specific to the operation over which the query operator is specified.

12. The system of claim 10, the collection type is a sub-type of a read-operation collection type.

13. The system of claim 10, the collection type is a return value of an operator specific to the operation.

14. The system of claim 10, the operation includes an output operator that specifies return values.

15. The system of claim 10 further comprising a code editor component that receives feedback from the first component based on the analysis performed by the first component.

16. The system of claim 10 further comprising a second component configured to transform the operation to a target query language.

17. The system of claim 16 the second component is configured to transform the operation a structured query language (SQL).

18. A computer-readable storage medium having program constructs stored thereon comprising:
a data type of a collection specific to one of an create, update, or delete operation; and
an interface that defines allowable language-integrated query operators as a function of the data type.

19. The computer-readable storage medium of claim 18, the data type is a subtype of a data type associated with a read operation.

20. The computer-readable storage medium of claim 18, the interface defines an allowable output clause to return information about an executed create, update, or delete operation.
